(19) United States
(12) Patent Application Publication
(10) Pub. No.: US 2024/0160796 A1
(43) Pub. Date: May 16, 2024

(54) METHOD AND SYSTEM FOR ANALYZING ANTI-EARTHQUAKE DESIGN OF FRACTIONAL-ORDER DAMPING AND VIBRATION-REDUCING STRUCTURE, DEVICE, AND MEDIUM

(71) Applicants: GUANGDONG ARTIFICIAL INTELLIGENCE AND DIGITAL ECONOMY LABORATORY(GUANGZHOU), Guangzhou (CN); SOUTH CHINA UNIVERSITY OF TECHNOLOGY, Guangzhou (CN)

(72) Inventors: Taicong Chen, Guangzhou (CN); Qin Guo, Guangzhou (CN)

(73) Assignees: GUANGDONG ARTIFICIAL INTELLIGENCE AND DIGITAL ECONOMY LABORATORY(GUANGZHOU), Guangzhou (CN); SOUTH CHINA UNIVERSITY OF TECHNOLOGY, Guangzhou (CN)

(21) Appl. No.: 18/236,408

(22) Filed: Aug. 22, 2023

(30) Foreign Application Priority Data
Nov. 7, 2022 (CN) 202211381404.0

(51) Int. Cl. G06F 30/13; G06F 17/13; G06F 30/20

(52) U.S. Cl. CPC G06F 30/13; G06F 17/13; G06F 30/20

(57) ABSTRACT

A method and system for analyzing an anti-earthquake design of a fractional-order damping and vibration-reducing structure, a device, and a medium relate to the field of designs for anti-earthquake structures. The method includes: establishing a motion equation of a cascaded structure that contains a fractional-order damping under the dynamic load; calculating a fractional-order derivative based on an Adams-Moulton algorithm, and constructing an equivalent linear time-invariant dynamic system based on the motion equation at each discrete moment; and establishing an explicit solution formula of the equivalent linear time-invariant dynamic system at each moment with reference to Newmark-β numerical integration, and solving a dynamic response. The method has good calculation precision, calculation stability, and calculation efficiency, is easy to be embedded into general dynamic analysis software, and is convenient for engineering applications.

### CROSS REFERENCE TO THE RELATED APPLICATIONS

This application is based upon and claims priority to Chinese Patent Application No. 202211381404.0, filed on Nov. 7, 2022, the entire contents of which are incorporated herein by reference.

### TECHNICAL FIELD

The present invention relates to the field of designs for anti-earthquake structures, and more particularly, to a method and system for analyzing an anti-earthquake design of a fractional-order damping and vibration-reducing structure, a device, and a medium.

### BACKGROUND

Fractional-order derivatives are widely used in the field of academic disciplines such as electromagnetism, thermodynamics, and fluid mechanics, are often used in vibration engineering to describe constitutive models of velocity-dependent dampers including viscoelastic dampers and magneto-rheological dampers, and can precisely fit a relationship between mechanical properties and factors such as temperature and frequency.

A structure containing fractional-order damping has a time-memory feature. Analytic calculation of a dynamic response of the structure usually needs to be converted to a Laplace domain or Fourier domain. A precise solution for a single-degree-of-freedom oscillator can be acquired only in a few cases. Relatively speaking, the numerical solution in a time domain has more practical significance. For Grunwald-Letnikov fractional-order derivatives, Oldham and Spanier proposed a G1 algorithm, which has been applied to random vibration analysis, sensitivity analysis and other studies. For more common Riemann-Liouville (RL) fractional-order derivatives in practice, Oldham and Spanier introduced a constant first-order change rate consumption within a time step length and proposed an L1 algorithm. Based on this algorithm, Koh and Kelly applied a central difference method to carry out dynamic analysis of a single-degree-of-freedom oscillator. Shokooh and Suarez applied the central difference method and an average acceleration method to solve a dynamic response of a ½-order oscillator system. Further, Singh and Chang introduced a constant second-order change rate assumption and a constant third-order change rate assumption, proposed a L1 -like algorithm, and developed an analysis method for an earthquake action of a vibration-reducing structure. In related application studies, due to introduction of these calculation assumptions, an initial starting condition often requires special calculation processing, and a calculation instability problem also needs to be avoided in the case of large damping.

Considering the frequency dependence of damper performances, in engineering practice, an equivalent stiffness matrix and a damping matrix of a damper are usually calculated approximately based on a fundamental frequency of a structure, and then a dynamic response is solved based on a quasi-linear structure. Although the engineering approximation algorithm is simple and efficient, it has certain errors in solving responses with significant high-order frequency effects such as acceleration, velocity, and damping force.

Therefore, a prior art algorithm for a dynamic response of a structure containing fractional-order damping has the defects of low calculation precision, poor calculation stability, and low calculation efficiency.

### SUMMARY

With respect to the defects of the prior art, the present invention provides a method and system for analyzing an anti-earthquake design of a fractional-order damping and vibration-reducing structure, a device, and a medium, which have good calculation precision, calculation stability, and calculation efficiency, are easy to be embedded into general dynamic analysis software, and are convenient for engineering applications.

To achieve the above objective, the technical solutions of the present invention are implemented as follows.

According to a first aspect, the present invention provides a method for analyzing an anti-earthquake design of a fractional-order damping and vibration-reducing structure, the method including:
establishing a motion equation of a cascaded structure that contains a fractional-order damping under the dynamic load;
calculating a fractional-order derivative based on an Adams-Moulton algorithm, and constructing an equivalent linear time-invariant dynamic system from the motion equation at each discrete moment; and
establishing an explicit solution formula of the equivalent linear time-invariant dynamic system at each moment with reference to Newmark-β numerical integration, and solving a dynamic response.

According to a second aspect, the present invention provides a system for analyzing an anti-earthquake design of a fractional-order damping and vibration-reducing structure, the system including:
a first processing unit, configured to: establish a motion equation of a cascaded structure that contains a fractional-order damping under the dynamic load;
a second processing unit, configured to: calculate a fractional-order derivative based on an Adams-Moulton algorithm, and construct an equivalent linear time-invariant dynamic system based on the motion equation at each discrete moment;
a third processing unit, configured to: establish an explicit solution formula of the equivalent linear time-invariant dynamic system at each moment with reference to Newmark-β numerical integration, and solve a dynamic response; and
an output unit, configured to: output a solution of the dynamic response.

According to a third aspect, the present invention provides an electronic device. The electronic device includes a processor and a memory, wherein the memory stores at least one instruction, at least one program, a code set, or an instruction set; and the at least one instruction, the at least one program, the code set, or the instruction set is loaded and executed by the processor, to implement the foregoing method for analyzing the anti-earthquake design of the fractional-order damping and vibration-reducing structure.

According to a fourth aspect, the present invention provides a computer-readable storage medium. The storage medium stores at least one instruction, at least one program, a code set, or an instruction set; and the at least one instruction, the at least one program, the code set, or the instruction set is loaded and executed by the processor, to implement the foregoing method for analyzing the anti-earthquake design of the fractional-order damping and vibration-reducing structure.

Compared with the prior art, the present invention has the following beneficial effects: targeted at a fractional-order damping structure and based on a numerical solution algorithm for a fractional-order derivative with high precision and strong stability, the present invention constructs the equivalent linear time-invariant dynamic system, and then establishes the explicit formula of dynamic integration with reference to the Newmark-β method, thereby implementing efficient time-domain numerical solution of the dynamic response of the structure. Based on calculation examples of a single-degree-of-freedom oscillator and a multi-degree-of-freedom vibration-reducing structure, the present invention compares and investigates the method in the present invention, an analytical solution, and various numerical algorithms, and verifies that the method of the present invention has good calculation precision, calculation stability, and calculation efficiency, is easy to be embedded into general dynamic analysis software, and is convenient for engineering applications.

### BRIEF DESCRIPTION OF THE DRAWINGS

To describe the technical schemes in the embodiments of the present invention more clearly, the following briefly introduces the accompanying drawings required in the embodiments. Apparently, the accompanying drawings in the following description show merely some embodiments of this application, and a person of ordinary skills in the art may still derive other drawings from these accompanying drawings without creative efforts.

FIG. 1 is a schematic structural diagram of a cascaded structure containing a fractional-order damping according to an embodiment of the present invention;

FIGS. 2A-2F are diagrams of calculation results of displacement time histories based on a time step length of 0.05 s under two loads and two kinds of damping according to an embodiment of the present invention;

FIG. 3 is a diagram of calculation results of the maximum response in each layer under the El Centro earthquake according to an embodiment of the present invention;

FIG. 4 is a flowchart of an analytical method according to an embodiment of the present invention;

FIG. 5 is a schematic structural diagram of a system for implementing a method according to an embodiment of the present invention; and

FIG. 6 is a schematic structural diagram of an electronic device for implementing a method according to an embodiment of the present invention.

### DETAILED DESCRIPTION OF THE EMBODIMENTS

The following clearly and completely describes the technical solutions in the embodiments of the present invention with reference to the accompanying drawings in the embodiments of the present invention. Apparently, the described embodiments are some but not all of the embodiments of this application. All other embodiments acquired by a person of ordinary skill in the art based on embodiments of the present invention without creative efforts shall fall within the protection scope of the present invention.

### Embodiments

It should be noted that, in the description, claims, and accompanying drawings of the present invention, the terms such as “first” and “second” are used for distinguishing similar objects, but are not necessarily used for describing a specific sequence or order. It should be understood that the data used in this way can be interchanged under appropriate circumstances, so that the embodiments of the present invention described herein can be implemented in an order other than the order illustrated or described herein. In addition, the terms “include” and “have” and any variations thereof in embodiments of the present invention are intended to cover the inclusion in a non-exclusive manner. For example, the process, method, system, product, or device that includes a series of steps or units need not to be limited to those steps or units as clearly listed, but may include other steps or units not clearly listed or inherent to the process, method, product, or device.

In the description of the present invention, “a plurality of” means at least two, for example, two or three, unless otherwise clearly and specifically limited. In addition, unless otherwise clearly specified and limited, terms such as “mounted”, “connected with”, and “connected to” should be understood in a broad sense. For example, a connection may be a fixed connection, a detachable connection, or an integrated connection, may be a mechanical connection or an electrical connection, may be a direct connection or an indirect connection via an intermediate medium, or may be an internal connection between two components. For a person of ordinary skill in the art, specific meanings of the above terms in the present invention may be understood based on specific situations.

The term “exemplary” used below means “used as an example, embodiment or illustration”. Any embodiment described as “exemplary” is not necessarily explained as being superior or better than other embodiments.

Aiming at an RL fractional-order damping structure, the present invention performs numerical solution expression on an RL fractional-order derivative by introducing a Caputo-type fractional-order derivative and an Adams-Moulton algorithm based on multi-step predictor-corrector, then constructs an equivalent linear time-invariant dynamic system at each discrete moment, and derives explicit formulas for calculation at each moment with reference to an unconditionally stable numerical integration scheme, thereby achieving high precision, strong stability, and direct and fast solution for a dynamic response. In a numerical calculation example, first, taking a single-degree-of-freedom oscillator being subjected to a simple harmonic load and a unit impulse as an example, an analytical solution, two L1-type direct algorithms and the method of the present invention are compared and investigated in terms of calculation precision and stability; and then, by taking a multi-layer damping and vibration-reducing structure being under earthquake action as an example, comprehensive performances of an iterative numerical algorithm, an engineering approximation algorithm and the method of the present invention are compared and investigated in terms of calculation precision and calculation efficiency, to test an engineering application prospect.

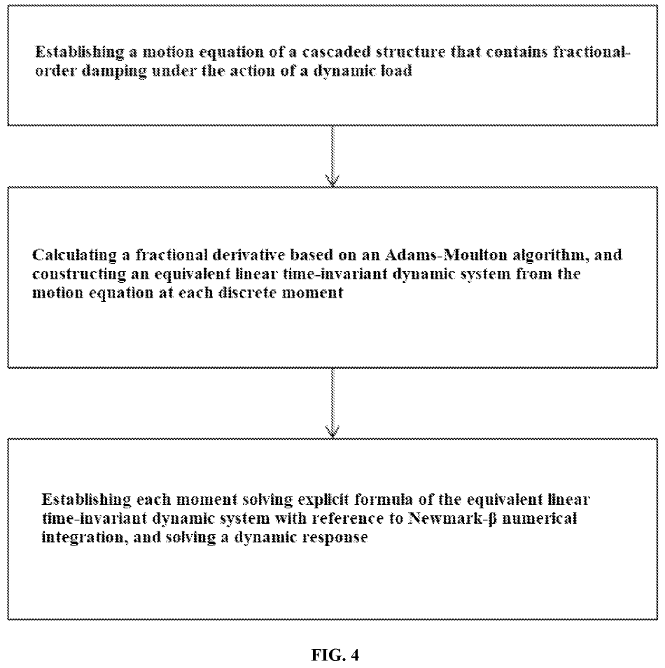

Based on this and referring to FIG. 4, the present invention provides a method for analyzing an anti-earthquake design of a fractional-order damping and vibration-reducing structure. The method may specifically include the following steps.

In Step 1, a motion equation of a cascaded structure that contains a fractional-order damping under the dynamic load is established.

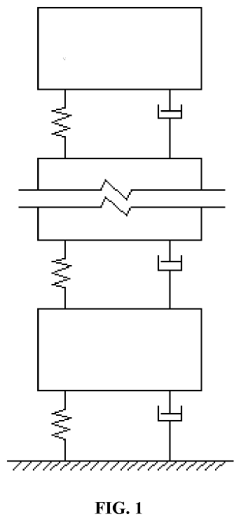

Specifically, as shown in FIG. 1 which shows a schematic structural diagram of a cascaded structure containing fractional-order damping according to an embodiment of the present invention. Without loss of generality, the method takes a cascaded structure into consideration, and provides each layer with a fractional-order damper. Under the dynamic load, the motion equation of the cascaded structure may be represented as follows:

$$\begin{matrix}M \ddot{X} + C \dot{X} + KX + Λ F = P ( t ) , \\ wherein & ( 1 ) \\ X = {[ {x}_{1} {x}_{2} ⋯ {x}_{n} ]}^{T} ; & ( 2 ) \\ F = {[ {f}_{1} {f}_{2} ⋯ {f}_{n} ]}^{T} ; & ( 3 ) \\ Λ = [ \begin{matrix}1 & - 1 & & & \\ & 1 & - 1 & & \\ & & ⋱ & ⋱ & \\ & & & 1 & - 1 \\ & & & & 1\end{matrix} ] , & ( 4 )\end{matrix}$$

wherein M, C, K respectively denote a mass matrix, a damping matrix, and a stiffness matrix of the structure; xᵢ, \dot{x}ᵢ, \ddot{x}ᵢ(i=1,2, . . . , n) respectively denote a displacement, a velocity, and an acceleration of the i^{th} layer; fᵢ denotes a restoring force of the i^{th}-layer fractional-order damper; and Λ denotes a positioning matrix of the restoring force of the damper.

A material constitutive equation of the fractional-order damper is described by using a generalized stress-strain relationship defined by Kasai:

τ(t)+aD^{δ}τ(t)=G(γ(t)+bD^{δ}γ(t) (5),

wherein τ(t) and γ(t) denote a shear stress and a shear strain of a material; G denotes an elastic parameter of the material: δ denotes a fractional order, 0<δ<1; a, b denote temperature and frequency-equivalent parameters; and D^{δ}=d^{δ}/dt^{δ} denotes an RL-type fractional-order derivative operator and is defined as follows:

$${D}^{δ} g ( t ) = \frac{1}{Γ ( 1 - δ )} \frac{d}{dt} {\int }_{0}^{t} \frac{g ( ζ )}{{( t - ζ )}^{δ}} d ζ , \qquad ( 6 )$$

wherein Γ(·) denotes a Gamma function.

It can be learned from Formula (5) that a relationship between the restoring force of the i^{th} damper and a displacement of each particle is as follows:

$${f}_{i} ( t ) + {aD}^{δ} {f}_{i} ( t ) = {k}^{′} ( {x}_{i} ( t ) - {x}_{i - 1} ( t ) ) + {k}^{′} {bD}^{δ} ( {x}_{i} ( t ) - {x}_{i - 1} ( t ) ) , \qquad ( 7 )$$

wherein k′=GA/h; and A and h respectively denote an area and a thickness of the damper.

Further, during numerical solution of the restoring force of the fractional-order damper, under the condition of 0<δ<1, an RL-type fractional-order derivative may be converted to the expression of a Caputo-type fractional-order derivative:

$${S}^{δ} g ( t ) = {( {}^{C} D )}^{δ} g ( t ) + \frac{{t}^{- δ} g ( 0 )}{Γ ( 1 - δ )} , \qquad ( 8 )$$

wherein ^{C}D^{δ} denotes a Caputo-type fractional-order derivative operator and is defined as follows:

$${}^{C} {D}^{δ} g ( t ) = \frac{1}{Γ ( 1 - δ )} {\int }_{0}^{t} \frac{\dot{g} ( ζ )}{{( t - ζ )}^{δ}} d ζ . \qquad ( 9 )$$

An integer-order derivative contained in a Caputo definition has a specific physical meaning and also facilitates processing of an initial condition. Therefore, the RL derivative may be solved conveniently by using a Caputo derivative.

Researchers attempt to use traditional L1 algorithms for the solution. For example, Oldham and Spanier discretize the Caputo derivative into a cumulative integration operation of a sequential time step length:

$${}^{C} {D}^{δ} g ( t ) = \frac{1}{Γ ( 1 - δ )} {\sum }_{j = 1}^{n - 1} {\int }_{( j - 1 ) Δ t}^{j Δ t} \frac{\dot{g} ( ζ )}{{( t - ζ )}^{δ}} d ζ . \qquad ( 10 )$$

In each time step length, assuming that a first-order change rate ġ(ζ) is a constant, that is,

$${\int }_{( j - 1 ) Δ t}^{j Δ t} \frac{\dot{g} ( ζ )}{{( t - ζ )}^{δ}} d ζ \approx \frac{g ( j Δ t ) - g ( ( j - 1 ) Δ t )}{Δ t} {\int }_{( j - 1 ) Δ t}^{j Δ t} \frac{1}{{( t - ζ )}^{δ}} d ζ , \qquad ( 11 )$$

approximate calculation may be implemented via independent integration of a time function. This L1 algorithm is essentially a single-step predictor algorithm whose precision and stability cannot be guaranteed fully. Other algorithms that introduce a constant second-order change rate assumption and a constant third-order change rate assumption are single-step predictor algorithms like the L1 algorithm, and have calculation performance similar to that of the L1 algorithm.

The present invention introduces the Adams-Moulton algorithm for numerical expression in view of the Caputo fractional-order derivative defined by Formula (9). According to the method, an integrand does not need to be assumed; and high-precision solution is performed by using a multi-step algorithm that contains a predictor-corrector mechanism. The method has absolute stability within an order of <δ<1, and has been widely used in the solution of a constant/variable-order fractional-order differential equation.

At an tₚ^{th} discrete moment, the Caputo-type fractional-order derivative based on the Adams-Moulton algorithm is solved as follows:

$${}^{C} {D}^{δ} g ( t ) = \frac{Δ {t}^{1 - δ}}{Γ ( 3 - δ )} {\sum }_{j = 0}^{p} {q}_{j , p} \dot{g} ( {t}_{j} ) , \qquad ( 12 )$$

wherein p=tₚ/Δt; and q_{j,p} is solved as follows:

if j=0,

q_{j,p}=(p−1)^{2-δ}−p^{1-δ}(p+δ−2); (1)

if 0<j<p,

q_{j,p}=(p−j−1)^{2-δ}−2(p−j)^{2-δ}−(p−j+1)^{2-δ}; and (2)

if j=p,

q_{j,p}−1. (3)

According to Formula (7), when g(t) is fᵢ(t), ġ(tⱼ) is approximately calculated by using a first-order difference [fᵢ(tⱼ)−fᵢ(tⱼ₋₁)]/Δt; and when g(t) is xᵢ(t)−xᵢ₋₁(t), ġ(tⱼ) is equal to \dot{x}ᵢ(tⱼ)−\dot{x}ᵢ₋₁(tⱼ).

In principle, numerical solution is performed on Formula (7) by using the foregoing method, and reciprocally iterative calculations are performed with the integral motion equation (1) of the structure, so that high-precision solution to the dynamic response of the structure can be achieved. However, the calculation efficiency of this iterative numerical algorithm is low, so special solution programming is difficult to be directly applied in general dynamic analysis software.

In the following of the present invention, linear system equivalence is performed based on the Adams-Moulton algorithm, thereby implementing efficient and direct solution.

In Step 2, a fractional-order derivative is calculated based on the Adams-Moulton algorithm, and an equivalent linear time-invariant dynamic system is constructed based on the motion equation at each discrete moment.

Specifically, at the tₚ^{th} discrete moment, it can be learned, by combining Formulas (2), (3), and (7), that a damping force vector and a particle displacement vector satisfy the following relationship:

$$F ( {t}_{p} ) = - a {D}^{δ} F ( {t}_{p} ) + {k}^{′} {Λ}^{T} X ( {t}_{p} ) + {k}^{′} b {Λ}^{T} {D}^{δ} X ( {t}_{p} ) . \qquad ( 13 )$$

With reference to Formulas (8) and (12), numerical solution expression is performed on D^{δ}F(tₚ) and D^{δ}X(tₚ), then results are substituted into Formula (13), and finally the following formula is acquired via sorting:

$$F ( {t}_{p} ) = \frac{λ Δ t}{μ + Δ t} {Λ}^{T} \dot{X} ( {t}_{p} ) + \frac{{k}^{′} Δ t}{μ + Δ t} {Λ}^{T} X ( {t}_{p} ) - B ( {t}_{p} ) , \qquad ( 14 )$$

$$wherein$$

$$μ = \frac{a Δ {t}^{1 - δ}}{Γ ( 3 - δ )} ; \qquad ( 15 )$$

$$λ = \frac{{k}^{′} b Δ {t}^{1 - δ}}{Γ ( 3 - δ )} ; \qquad ( 16 )$$

$$and$$

$$B ( {t}_{p} ) = - \frac{λ Δ t}{μ + Δ t} {Λ}^{T} {\sum }_{j = 1}^{p - 1} {q}_{j , p} \dot{X} ( {t}_{j} ) + \frac{μ Δ t}{μ + Δ t} \cdot ( {\sum }_{j = 1}^{p - 1} {q}_{j , p} \frac{F ( {t}_{j} ) - F ( {t}_{j - 1} )}{Δ t} - \frac{F ( {t}_{p - 1} )}{Δ t} ) , \qquad ( 17 )$$

wherein B(tₚ) is simplified by using a zero initial condition, that is, F(0)=\dot{F}(0)=X(0)=\dot{X}(0)=0.

Formula (14) is substituted into the integral motion equation (1) of the structure at the tₚ^{th} discrete moment, and finally the following formula is acquired via sorting:

$$M \ddot{X} ( {t}_{p} ) + \overline{C} \dot{X} ( {t}_{p} ) + \overline{K} X ( {t}_{p} ) = \overline{P} ( {t}_{p} ) , \qquad ( 18 )$$

$$wherein$$

$$\overline{C} = C + \frac{λ Δ t}{μ + Δ t} Λ {Λ}^{T} ; \qquad ( 19 )$$

$$\overline{K} = K + \frac{{k}^{′} Δ t}{μ + Δ t} Λ {Λ}^{T} ; \qquad ( 20 )$$

$$and$$

$$\overline{P} ( {t}_{p} ) = P ( {t}_{p} ) + Λ B ( {t}_{p} ) . \qquad ( 21 )$$

It can be learned from Formula (18) that the structure at this moment has been equalized to a linear dynamic system, and that the mass, damping and stiffness matrices of the equivalent system are all constant matrices, and are only related to an original system matrix and damper parameters, but are independent of a structural response. Therefore, the structure is a linear time-invariant dynamic system.

In Step 3, an explicit solution formula of the equivalent linear time-invariant dynamic system at each moment is established with reference to Newmark-β numerical integration, and a dynamic response is solved.

Specifically, for the equivalent linear time-invariant dynamic system acquired above, the dynamic response of the structure may be solved conveniently using any general dynamic time history calculation scheme.

Considering that a widely used Newmark-β numerical integration scheme has unconditional stability and does not require additional processing of a starting calculation problem, the present invention uses the Newmark-β scheme as an example to establish the following formulas by which the dynamic response is solved by moment (wherein p=1,2, . . . , n):

$$X ( {t}_{p} ) = {\tilde{K}}^{- 1} \tilde{P} ( {t}_{p} ) ; \qquad ( 22 )$$

$$\dot{X} ( {t}_{p} ) = {a}_{1} ( X ( {t}_{p} ) - X ( {t}_{p - 1} ) ) - {a}_{4} \dot{X} ( {t}_{p - 1} ) - {a}_{5} \ddot{X} ( {t}_{p - 1} ) ; \qquad ( 23 )$$

$$\ddot{X} ( {t}_{p} ) = {a}_{0} ( X ( {t}_{p} ) - X ( {t}_{p - 1} ) ) - {a}_{2} \dot{X} ( {t}_{p - 1} ) - {a}_{3} \ddot{X} ( {t}_{p - 1} ) ; \qquad ( 24 )$$

$$and$$

$$F ( {t}_{p} ) = \frac{λ Δ t}{μ + Δ t} {Λ}^{T} \dot{X} ( {t}_{p} ) + \frac{{k}^{′} Δ t}{μ + Δ t} {Λ}^{T} X ( {t}_{p} ) - B ( {t}_{p} ) , \qquad ( 25 )$$

$$wherein$$

$$\tilde{K} = \overline{K} + {a}_{0} M + {a}_{1} \overline{C} ; \qquad ( 26 )$$

$$\tilde{P} ( {t}_{p} ) = P ( {t}_{p} ) + Λ B ( {t}_{p} ) + M ( {a}_{0} X ( {t}_{P - 1} ) + {a}_{2} \dot{X} ( {t}_{P - 1} ) + {a}_{3} \ddot{X} ( {t}_{P - 1} ) ) ; \qquad ( 27 )$$

$$+ \overline{C} ( {a}_{1} X ( {t}_{P - 1} ) + {a}_{4} \dot{X} ( {t}_{P - 1} ) + {a}_{5} \ddot{X} ( {t}_{P - 1} ) ) ,$$

$$and$$

$$\{ \begin{matrix}{a}_{0} = 1 / ( βΔ {t}^{2} ) & {a}_{1} = γ / ( βΔ t ) \\ {a}_{2} = 1 / ( βΔ t ) & {a}_{3} = 1 / ( 2 β ) - 1 \\ {a}_{4} = γ / β - 1 & {a}_{5} = Δ t ( γ / β - 2 ) / 2\end{matrix} . \qquad ( 28 )$$

It can be learned from Formulas (17) to (28) that: (1) R is a time-invariant matrix, only needs to be calculated at a t₁^{th} moment, and does not need to be updated by moment; and (2) \tilde{P}(tₚ) is linearly related to a response at a previous moment and does not require any iterative solution. Therefore, the new algorithm of the present invention has higher calculation efficiency than an iterative numerical algorithm, and is also easy to be directly applied in general dynamic analysis software.

To test the precision and stability of the method of the present invention, by taking a fractional-order damping single-degree-of-freedom oscillator being respectively subjected to a simple harmonic load and a unit impulse as an example, calculation results of an existing analytical solution, the method of the present invention, and two common L1 algorithms are compared and investigated. A motion equation of an investigated oscillator is:

m\ddot{x}+2ηmωₙ^{3/2}D^{1/2}x+kx=P(t),

wherein m=1; k=100; ωₙ=10 rad/s; and η is a fractional-order damping ratio parameter. P(t) takes the following two load types into consideration: (1) a simple harmonic load, F₀ sin(Ωt), F₀=100, and Ω=8 rad/s; and (2) a unit impulse at an initial moment.

It is known that analytical solutions of a steady-state displacement response of the simple harmonic load and a displacement response of the unit impulse respectively are ^{[12, 28, 29]},

$$x ( t ) = \frac{{F}_{0} sin ( Ω t - {ϕ}_{3} ) / m}{\sqrt{{( {ω}_{n}^{2} - {Ω}^{2} + \sqrt{2} η {ω}_{n}^{3 / 2} {Ω}^{1 / 2} )}^{2} + 2 {η}^{2} {ω}_{n}^{3} Ω}} , and$$

$$h ( t ) = \frac{γ}{m {ω}_{d}} {e}^{- {ηω}_{n} t / \sqrt{χ}} sin ( {ω}_{d} t + ϕ ) + \frac{4 η {ω}_{n}^{3 / 2}}{π m} {\int }_{0}^{∞} \frac{{u}^{2} {e}^{- {u}^{2} t}}{{( {u}^{4} + {ω}_{n}^{2} )}^{2} + {( 2 η {ω}_{n}^{3 / 2} u )}^{2}} d u ,$$

wherein for details about calculation of key parameters in these formulas, refer to references.

Two typical L1 algorithms for calculation and comparison are an L1-central difference method and an L1-average acceleration method that are proposed by Shokooh and Suarez and that have been applied.

During application of the method of the present invention, calculation parameters corresponding to the oscillator are a=0, b=10, C=0, and k′=2ηωₙ^{3/2}/b; an original stiffness is k₀=k−k; and Newmark-β calculation parameters are γ=½ and β=¼.

Calculations are respectively carried out for a small damping oscillator (η=1) and a large damping oscillator (η=5). A total calculation duration under the simple harmonic load is 100 s, to obtain a steady-state response. The calculation precision is investigated for three time step lengths (0.03 s, 0.02 s, and 0.01 s). A total calculation duration under the unit impulse is 1 s. The calculation precision is investigated for three time step lengths (0.002 s, 0.001 s, and 0.0005 s). In addition, to investigate the stability of an algorithm, calculations with a large time step length (0.05 s) are also carried out under two loads of the two damping oscillators.

TABLE 1
Representative displacement calculation results based on three
time step lengths under two loads and two damping cases

| | | Time step | | Method of | | L1-central | | | |
|---|---|---|---|---|---|---|---|---|---|
| Load | Damping | lengths | Analytical | the present | Error | difference | Error | L1-average | Error |
| type | η | (s) | solution | invention | (%) | method | (%) | acceleration | (%) |
| Simple | 1 | 0.03 | 0.4840714 | 0.4850214 | 0.196 | 0.4772257 | −1.434 | 0.4788353 | −1.082 |
| harmonic | | 0.02 | 0.4856138 | 0.4860999 | 0.100 | 0.4813347 | −0.889 | 0.4820995 | −0.724 |
| | | 0.01 | 0.4856138 | 0.4857551 | 0.029 | 0.4840347 | −0.326 | 0.4842259 | −0.286 |
| | 5 | 0.03 | 0.1084471 | 0.1085594 | 0.104 | 0.1068305 | −1.513 | 0.1069147 | −1.413 |
| | | 0.02 | 0.1084008 | 0.1085094 | 0.100 | 0.1075122 | −0.827 | 0.1075445 | −0.790 |
| | | 0.01 | 0.1086626 | 0.1087642 | 0.094 | 0.1084152 | −0.228 | 0.1084239 | −0.220 |
| Impulse | 1 | 0.0020 | 0.0457426 | 0.0457341 | −0.019 | 0.0457711 | 0.062 | 0.0457585 | 0.035 |
| | | 0.0010 | 0.0457460 | 0.0457439 | −0.005 | 0.0457552 | 0.020 | 0.0457522 | 0.014 |
| | | 0.0005 | 0.0457460 | 0.0457455 | −0.001 | 0.0457491 | 0.007 | 0.0457484 | 0.005 |
| | 5 | 0.0020 | 0.0180502 | 0.0180359 | −0.079 | 0.0181014 | 0.283 | 0.0180810 | 0.171 |
| | | 0.0010 | 0.0180502 | 0.0180467 | −0.019 | 0.0180672 | 0.094 | 0.0180621 | 0.066 |
| | | 0.0005 | 0.0180503 | 0.0180495 | −0.004 | 0.0180560 | 0.032 | 0.0180547 | 0.024 |

Calculation results under three time step lengths are shown in Table 1, wherein results of displacement amplitudes in a steady state are given for the simple harmonic load, and results of maximum transient displacements are given for the unit impulse. It can be seen from the results in the table that as the time step length decreases, the calculation precision of the three numerical methods is improved, wherein the precision of the results of the method of the present invention is the highest under each step, and the error level of the method of the present invention is better than those of the two L1 algorithms by nearly one order of magnitude.

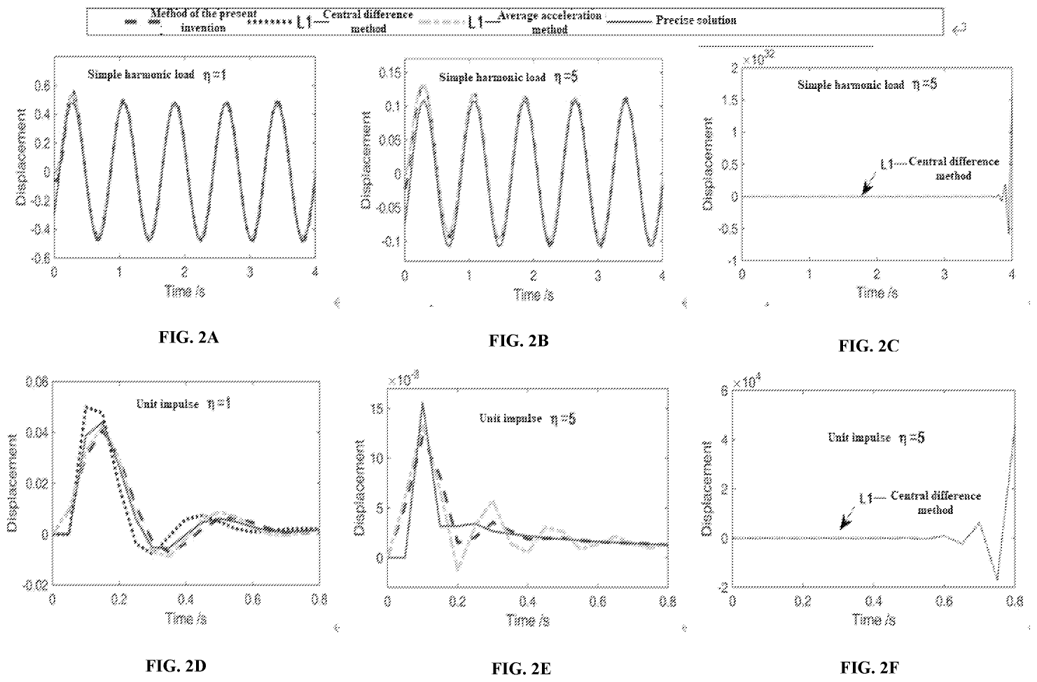

Displacement time history results under the time step length of 0.05 s are shown in FIGS. 2A-2F. It can be learned via observation that, when a large time step length is used:
(1) in the case of small damping, the three numerical methods can keep calculation stable, but there are certain calculation errors (see FIG. 2A and FIG. 2D); and
(2) in the case of large damping, the method of the present invention and the L1-average acceleration method can still keep calculation stable, but there are large calculation errors (see FIG. 2B and FIG. 2E), while the L1-central difference method is incapable of keeping calculation stable (see FIG. 2C and FIG. 2F); and although the time step length of 0.05 s is sufficient to satisfy a calculation stability requirement of less than Tₙ/π (0.507 s) or even more stringently less than or equal to 0.1 Tₙ (0.159 s), a calculation divergence problem still occurs.

To test the application prospect of the method in engineering practice, by taking a 10-layer viscoelastic damping steel frame structure being subjected to an earthquake action as an example, comprehensive performances of the method of the present invention, the iterative numerical algorithm, and the engineering approximation algorithm are compared and investigated in terms of calculation precision and calculation efficiency.

Under the consideration of the El Centro (NS, 1940) earthquake whose acceleration peak is 200 Gal, a mass for each layer of the structure is m=8×10⁵ Kg; an inter-layer stiffness is k=2×10⁸ N/m; a damping matrix is C=0.0785 M+0.0029K; and parameters of an inter-layer damper are A=0.0976 m², h=0.0635 m, G=2.5×10⁶ N/m², a=0.0347, b=4.16, and δ=0.71.

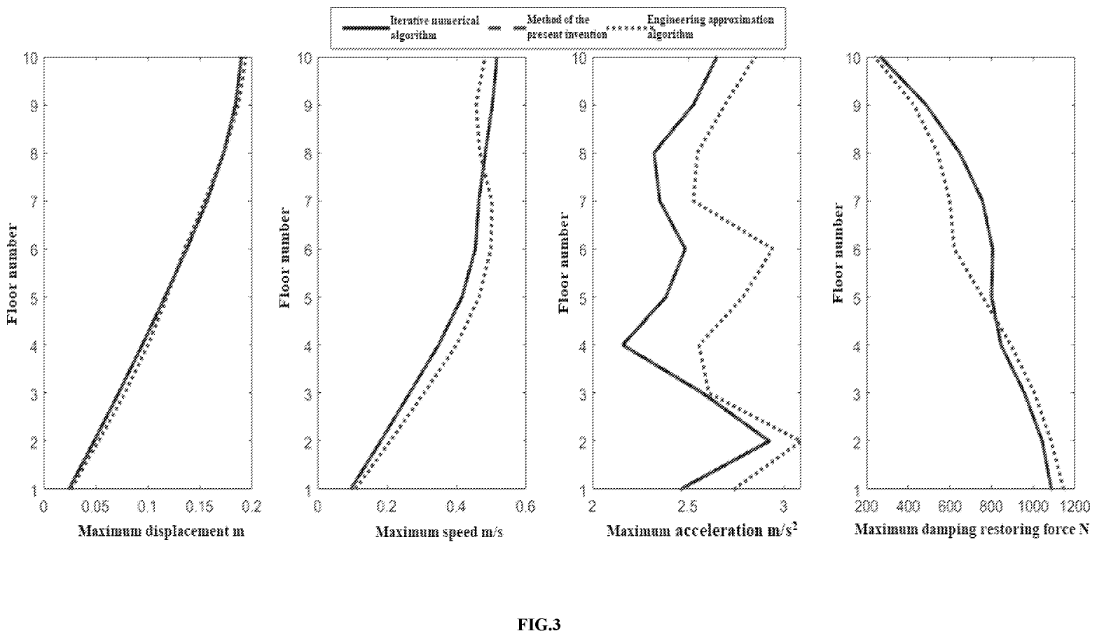

Results that include the maximum displacement, velocity, acceleration, and damping restoring force of each layer of the structure and are calculated by using the three methods and the step length of 0.02 s are shown in FIG. 3. It can be seen from the figure that the engineering approximation algorithm based on the fundamental frequency of the structure has certain deviations when compared with the iterative numerical algorithm, wherein a maximum deviation of displacement is about 5%, a maximum deviation of velocity is about 10%, and maximum deviations of acceleration and damping restoring force are about 20%. However, various response results of the method of the present invention and the iterative numerical algorithm are almost consistent.

When a personal computer (Intel i5-12400 CPU, internal memory: 8G) is used for calculation, calculation times of the iterative numerical algorithm, the engineering approximation algorithm, and the method of the present invention are 54.805 s, 2.584 s, and 3.829 s, respectively. It can be learned from comparison that the calculation efficiency of the method of the present invention is equivalent to that of the engineering approximation algorithm, and is more than 10 times higher than that of the iterative numerical algorithm. This shows that the method of the present invention has high comprehensive advantages in terms of calculation precision and calculation efficiency.

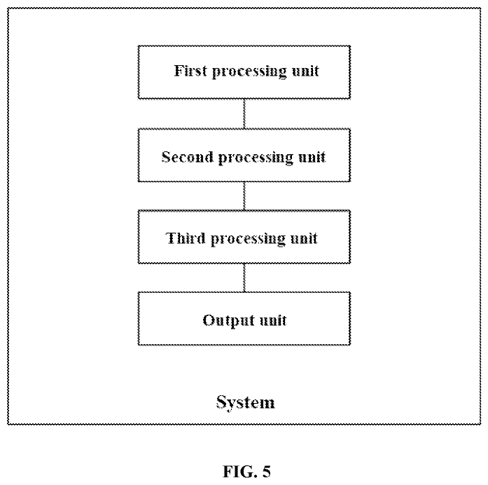

Referring to FIG. 5, based on the same inventive concept, an embodiment of the present invention further provides a system for analyzing an anti-earthquake design of a fractional-order damping and vibration-reducing structure. The system includes: a first processing unit, a second processing unit, a third processing unit, and an output unit. Specifically, the first processing unit is configured to: establish a motion equation of a cascaded structure that contains fractional-order damping under a dynamic load; the second processing unit is configured to: calculate a fractional-order derivative based on an Adams-Moulton algorithm, and construct an equivalent linear time-invariant dynamic system based on the motion equation at each discrete moment; the third processing unit is configured to: establish an explicit solution formula of the equivalent linear time-invariant dynamic system at each moment with reference to Newmark-β numerical integration, and solve a dynamic response; and the output unit is configured to: output a solution of the dynamic response.

Because this system corresponds to the method for analyzing the anti-earthquake design of a fractional-order damping and vibration-reducing structure in the embodiments of the present invention, and a problem-solving principle of the system is similar to that of this method. For details about implementation of the system, reference may be made to the implementation process of the foregoing method embodiment. No description is provided again.

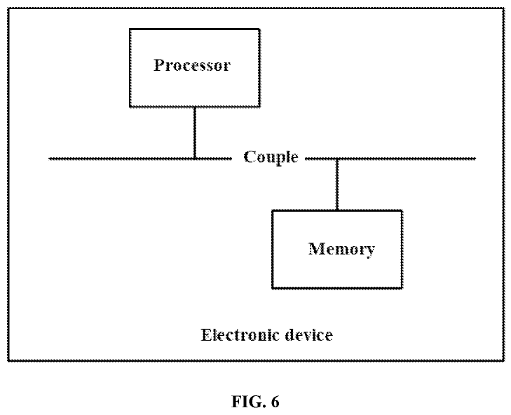

Referring to FIG. 6, based on the same inventive concept, an embodiment of the present invention further provides an electronic device. The electronic device includes a processor and a memory, wherein the memory stores at least one instruction, at least one program, a code set, or an instruction set; and the at least one instruction, the at least one program, the code set, or the instruction set is loaded and executed by the processor, to implement the foregoing method for analyzing the anti-earthquake design of the fractional-order damping and vibration-reducing structure.

It may be understood that the memory may include a random-access memory (RAM) or a read-only memory. Optionally, the memory includes a non-transitory computer-readable storage medium. The memory may be configured to store an instruction, a program, code, a code set, or an instruction set. The memory may include a program storage area and a data storage area. The program storage area may store an instruction used for implementing an operating system, an instruction used for implementing at least one function, an instruction used for implementing each of the foregoing method embodiments, and the like. The data storage area may store data created based on use of a server, and the like.

The processor may include one or more processing cores. The processor connects various parts within the entire server by using various interfaces and circuits, and performs various functions of the server and processes data by running or executing the instruction, the program, the code set, or the instruction set stored in the memory and invoking data stored in the memory. Optionally, the processor may be implemented by using at least one hardware form of a digital signal processor (DSP), a field-programmable gate array (FPGA), and a programmable logic array (PLA). The processor may integrate one of or a combination of a central processing unit (CPU), a modem, and the like. The CPU mainly processes an operating system, an application program, and the like. The modem is configured to process wireless communication. It may be understood that, alternatively, the modem may be implemented by using only one chip, without being integrated into the processor.

Because the electronic device corresponds to the method for analyzing the anti-earthquake design of the fractional-order damping and vibration-reducing structure in the embodiments of the present invention, and the problem-solving principle of the electronic device is similar to that of this method. Therefore, for details about implementation of the electronic device, reference may be made to the implementation process of the foregoing method embodiment. No description is provided again.

Based on the same inventive concept, an embodiment of the present invention further provides a computer-readable storage medium. The storage medium stores at least one instruction, at least one program, a code set, or an instruction set; and the at least one instruction, the at least one program, the code set, or the instruction set is loaded and executed by the processor, to implement the foregoing method for analyzing the anti-earthquake design of the fractional-order damping and vibration-reducing structure.

A person of ordinary skill in the art may understand that all or some of the steps of the methods in the embodiments may be completed by a program instructing related hardware. The program may be stored in a computer-readable storage medium. The storage medium includes a read-only memory (ROM), a random-access memory (RAM), a programmable read-only memory (PROM), an erasable programmable read-only memory (EPROM), a one-time programmable read-only memory (OTPROM), an electrically-erasable programmable read-only memory (EEPROM), a compact disc read-only memory (CD-ROM), or another optical disk memory, a magnetic disk memory, a magnetic tape memory, or any other medium that can be configured to carry or store data and that is computer-readable.

Because this storage medium corresponds to the method for analyzing the anti-earthquake design of the fractional-order damping and vibration-reducing structure in the embodiments of the present invention, and the problem-solving principle of the storage medium is similar to that of this method. Therefore, for details about implementation of the storage medium, reference may be made to the implementation process of the foregoing method embodiment. No description is provided again.

In some possible implementations, various aspects of the method in the embodiments of the present invention may also be implemented in a form of a program product. The program product includes a program code. When the program product runs on a computer device, the program code is used to enable the computer device to perform the steps in the method for analyzing the anti-earthquake design of the fractional-order damping and vibration-reducing structure according to various exemplary implementations of this application described in this specification. Executable computer program codes or “codes” used to execute the embodiments may be compiled in high-level programming languages such as C, C++, C#, Smalltalk, Java, JavaScript, Visual Basic, a structured query language (for example, Transact-SQL), or Perl, or another programming language.

In the description of this specification, descriptions with reference to terms such as “an embodiment”, “some embodiments”, “an example”, “a specific example” and “some examples” indicate that specific features, structures, materials or characteristics described in combination with the embodiment(s) or example(s) are included in at least one embodiment or example of the present invention. In this specification, schematic representation of the above terms is not necessarily directed to the same embodiment or example. Furthermore, the specific features, structures, materials, or characteristics described may be combined in a suitable manner in any one or more of embodiments or examples. In addition, those skilled in the art may integrate and combine different embodiments or examples described in this specification and characteristics of the different embodiments or examples without mutual contradiction.

The above embodiments are only for explaining the technical concept and features of the present invention, and the objective thereof is to enable those of ordinary skill in the art to understand the content of the present invention and implement therefrom, but not to limit the protection scope of the present invention. Any equivalent changes or modifications made according to the essence of the present invention shall fall within the protection scope of the present invention.

What is claimed is:

1. A method for analyzing an anti-earthquake design of a fractional-order damping and vibration-reducing structure, performed by a processor, the method comprising:
establishing, by the processor, a motion equation of a cascaded structure that contains fractional-order damping under a dynamic load;
calculating, by the processor, a fractional-order derivative based on an Adams-Moulton algorithm, and constructing an equivalent linear time-invariant dynamic system based on the motion equation at each discrete moment;
establishing, by the processor, an explicit solution formula of the equivalent linear time-invariant dynamic system at each moment with reference to Newmark-β numerical integration, and solving a dynamic response; and
outputting, by the processor, a solution of the dynamic response to engineering applications, wherein
the cascaded structure that contains the fractional-order damping is a cascaded structure in which each layer is provided with a fractional-order damper; and the motion equation contains a restoring force model of the fractional-order damper;
the motion equation is expressed as:
$$M \ddot{X} + C \dot{X} + K X + Λ F = P ( t ) , \qquad ( 1 )$$
$$wherein$$
$$X = {[ \begin{matrix}{x}_{1} & {x}_{2} & … & {x}_{n}\end{matrix} ]}^{T} ; \qquad ( 2 )$$
$$F = {[ \begin{matrix}{f}_{1} & {f}_{2} & … & {f}_{n}\end{matrix} ]}^{T} ; \qquad ( 3 )$$
$$and$$
$$Λ = [ \begin{matrix}1 & - 1 & & & \\ & 1 & - 1 & & \\ & & ⋱ & ⋱ & \\ & & & 1 & - 1 \\ & & & & 1\end{matrix} ] , \qquad ( 4 )$$
wherein M, C, K respectively denote a mass matrix, a damping matrix, and a stiffness matrix of the structure; xᵢ, \dot{x}ᵢ, \ddot{x}ᵢ respectively denote a displacement, a velocity, and an acceleration of an i^{th} layer; i=1,2, . . . , n ; fᵢ denotes a restoring force of an i^{th}-layer fractional-order damper; and Λ denotes a positioning matrix of the restoring force of the damper;
for the restoring force model of the fractional-order damper:
a material constitutive equation of the fractional-order damper is described by using a generalized stress-strain relationship defined by Kasai:
τ(t)+aD^{δ}τ(t)=G(γ(t)+bD^{δ}γ(t) (5),
wherein τ(t) and γ(t) denote a shear stress and a shear strain of a material; G denotes an elastic parameter of the material: δ denotes a fractional order, 0<δ<1; a, b denote temperature and frequency-equivalent parameters; and D^{δ}=d^{δ}/dt^{δ} denotes an RL-type fractional-order derivative operator and is defined as follows:
$${D}^{δ} g ( t ) = \frac{1}{Γ ( 1 - δ )} \frac{d}{d t} {\int }_{0}^{t} \frac{g ( ζ )}{{( t - ζ )}^{δ}} d ζ , \qquad ( 6 )$$
wherein Γ(·) denotes a Gamma function;
it can be learned from Formula (5) that a relationship between the restoring force of the i^{th} damper and a displacement of each particle is as follows:
$${f}_{i} ( t ) + a {D}^{δ} {f}_{i} ( t ) = {k}^{′} ( {x}_{i} ( t ) - {x}_{i - 1} ( t ) ) + {k}^{′} b {D}^{δ} ( {x}_{i} ( t ) - {x}_{i - 1} ( t ) ) , \qquad ( 7 )$$
wherein k′=GA/h; and A and h respectively denote an area and a thickness of a damper;
under a condition of 0<δ<1, an RL-type fractional-order derivative is allowed to be converted to an expression of a Caputo-type fractional-order derivative:
$${D}^{δ} g ( t ) = {}^{C} {D}^{δ} g ( t ) + \frac{{t}^{- δ} g ( 0 )}{Γ ( 1 - δ )} , \qquad ( 8 )$$
wherein ^{C}D^{δ} denotes a Caputo-type fractional-order derivative operator and is defined as follows:
$${}^{C} {D}^{δ} g ( t ) = \frac{1}{Γ ( 1 - δ )} {\int }_{0}^{t} \frac{\dot{g} ( ζ )}{{( t - ζ )}^{δ}} d ζ , \qquad ( 9 )$$
wherein at an tₚ^{th} discrete moment, the Caputo-type fractional-order derivatives based on the Adams-Moulton algorithm is solved as follows:
$${}^{C} {D}^{δ} g ( {t}_{p} ) = \frac{Δ {t}^{1 - δ}}{Γ ( 3 - δ )} {\sum }_{j = 0}^{p} {q}_{j , p} \dot{g} ( {t}_{j} ) , \qquad ( 10 )$$
wherein p=tₚ/Δt; and q_{j,p} is solved as follows:
if j=0,
q_{j,p}=(p−1)^{2-δ}−p^{1-δ}(p+δ−2); (1)
if 0<j<p,
q_{j,p}=(p−j−1)^{2-δ}−2(p−j)^{2-δ}−(p−j+1)^{2-δ}; and (2)
if j=p,
q_{j,p}−1. (3)
wherein according to Formula (7), when g(t) is fᵢ(t), ġ(tⱼ) is approximately calculated by using a first-order difference [fᵢ(tⱼ)−fᵢ(tⱼ₋₁)]/Δt; and when g(t) is xᵢ(t)−xᵢ₋₁(t), ġ(tⱼ) is \dot{x}ᵢ(tⱼ)−\dot{x}ᵢ₋₁(tⱼ);
the equivalent linear time-invariant dynamic system is constructed in the following specific steps:
at the tₚ^{th} discrete moment, it can be learned, by combining Formulas (2), (3), and (7), that a damping force vector and a particle displacement vector satisfy the following relationship:
$$F ( {t}_{p} ) = - a {D}^{δ} F ( {t}_{p} ) + {k}^{′} {Λ}^{T} X ( {t}_{p} ) + {k}^{′} b {Λ}^{T} {D}^{δ} X ( {t}_{p} ) , \qquad ( 11 )$$
wherein with reference to Formulas (8) and (12), numerical solution expression is performed on D^{δ}F(tₚ) and D^{δ}X(tₚ), then results are substituted into Formula (11), and finally the following formula is acquired via sorting:
$$F ( {t}_{p} ) = \frac{λ Δ t}{μ + Δ t} {Λ}^{T} \dot{X} ( {t}_{p} ) + \frac{{k}^{′} Δ t}{μ + Δ t} {Λ}^{T} X ( {t}_{p} ) - B ( {t}_{p} ) , \qquad ( 12 )$$
$$wherein$$
$$μ = \frac{a Δ {t}^{1 - δ}}{Γ ( 3 - δ )} ; \qquad ( 13 )$$
$$λ = \frac{{k}^{′} b Δ {t}^{1 - δ}}{Γ ( 3 - δ )} ; \qquad ( 14 )$$
$$and$$
$$B ( {t}_{p} ) = - \frac{λ Δ t}{μ + Δ t} {Λ}^{T} {\sum }_{j = 1}^{p - 1} {q}_{j , p} \dot{X} ( {t}_{j} ) + \frac{μ Δ t}{μ + Δ t} \cdot ( {\sum }_{j = 1}^{p - 1} {q}_{j , p} \frac{F ( {t}_{j} ) - F ( {t}_{j - 1} )}{Δ t} - \frac{F ( {t}_{p - 1} )}{Δ t} ) , \qquad ( 15 )$$
wherein B(tₚ) is simplified by using a zero initial condition, that is, F(0)=\dot{F}(0)=X(0)=\dot{X}(0)=0; and
Formula (12) is substituted into the integral motion equation (1) of the structure at the tₚ^{th} discrete moment, and finally the following formula is acquired via sorting:
$$M \ddot{X} ( {t}_{p} ) + \overline{C} \dot{X} ( {t}_{p} ) + \overline{K} X ( {t}_{p} ) = \overline{P} ( {t}_{p} ) , \qquad ( 16 )$$
$$wherein$$
$$\overline{C} = C + \frac{λ Δ t}{μ + Δ t} Λ {Λ}^{T} ; \qquad ( 17 )$$
$$\overline{K} = K + \frac{{k}^{′} Δ t}{μ + Δ t} Λ {Λ}^{T} ; \qquad ( 18 )$$
$$and$$
$$\overline{P} ( {t}_{p} ) = P ( {t}_{p} ) + Λ B ( {t}_{p} ) . \qquad ( 19 )$$

2. The method for analyzing the anti-earthquake design of the fractional-order damping and vibration-reducing structure according to claim 1, wherein
the step of establishing the explicit solution formula of the equivalent linear time-invariant dynamic system at each moment with reference to Newmark-β numerical integration comprises:
establishing moment-by-moment solution formulas of the dynamic response based on Newmark-β, the formulas being as follows:
$$X ( {t}_{p} ) = {\tilde{K}}^{- 1} \tilde{P} ( {t}_{p} ) ; \qquad ( 20 )$$
$$\dot{X} ( {t}_{p} ) = {a}_{1} ( X ( {t}_{p} ) - X ( {t}_{p - 1} ) ) - {a}_{4} \dot{X} ( {t}_{p - 1} ) - {a}_{5} \ddot{X} ( {t}_{p - 1} ) ; \qquad ( 21 )$$
$$\ddot{X} ( {t}_{p} ) = {a}_{0} ( X ( {t}_{p} ) - X ( {t}_{p - 1} ) ) - {a}_{2} \dot{X} ( {t}_{p - 1} ) - {a}_{3} \ddot{X} ( {t}_{p - 1} ) ; \qquad ( 22 )$$
$$and$$
$$F ( {t}_{p} ) = \frac{λ Δ t}{μ + Δ t} {Λ}^{T} \dot{X} ( {t}_{p} ) + \frac{{k}^{′} Δ t}{μ + Δ t} {Λ}^{T} X ( {t}_{p} ) - B ( {t}_{p} ) , \qquad ( 23 )$$
$$wherein$$
$$\tilde{K} = \overline{K} + {a}_{0} M + {a}_{1} \overline{C} ; \qquad ( 24 )$$
$$\tilde{P} ( {t}_{p} ) = P ( {t}_{p} ) + Λ B ( {t}_{p} ) ; \qquad ( 25 )$$
$$and$$
$$+ M ( {a}_{0} X ( {t}_{P - 1} ) + {a}_{2} \dot{X} ( {t}_{P - 1} ) + {a}_{3} \ddot{X} ( {t}_{P - 1} ) )$$
$$+ \overline{C} ( {a}_{1} X ( {t}_{P - 1} ) + {a}_{4} \dot{X} ( {t}_{P - 1} ) + {a}_{5} \ddot{X} ( {t}_{P - 1} ) )$$
$$\{ \begin{matrix}{a}_{0} = 1 / ( βΔ {t}^{2} ) & {a}_{1} = γ / ( βΔ t ) \\ {a}_{2} = 1 / ( βΔ t ) & {a}_{3} = 1 / ( 2 β ) - 1 \\ {a}_{4} = γ / β - 1 & {a}_{5} = Δ t ( γ / β - 2 ) / 2\end{matrix} , \qquad ( 26 )$$
$$wherein p = 1 , 2 , … , n .$$

3. A system for analyzing an anti-earthquake design of a fractional-order damping and vibration-reducing structure, comprising:
a first processor configured to: establish a motion equation of a cascaded structure that contains fractional-order damping under a dynamic load;
a second processor configured to: calculate a fractional-order derivative based on an Adams-Moulton algorithm, and construct an equivalent linear time-invariant dynamic system based on the motion equation at each discrete moment;
a third processor configured to: establish an explicit solution formula of the equivalent linear time-invariant dynamic system at each moment with reference to Newmark-β numerical integration, and solve a dynamic response; and
the system outputs a solution of the dynamic response to engineering applications, wherein
the cascaded structure that contains the fractional-order damping is a cascaded structure in which each layer is provided with a fractional-order damper; and the motion equation contains a restoring force model of the fractional-order damper;
the motion equation is expressed as:
$$M \ddot{X} + C \dot{X} + K X + Λ F = P ( t ) , \qquad ( 1 )$$
$$wherein$$
$$X = [ {\begin{matrix}{x}_{1} & {x}_{2} & … & {x}_{n} ]\end{matrix}}^{T} ; \qquad ( 2 )$$
$$F = [ {\begin{matrix}{f}_{1} & {f}_{2} & … & {f}_{n} ]\end{matrix}}^{T} ; \qquad ( 3 )$$
$$and$$
$$Λ = [ \begin{matrix}1 & - 1 & & & \\ & 1 & - 1 & & \\ & & ⋱ & ⋱ & \\ & & & 1 & - 1 \\ & & & & 1\end{matrix} ] , \qquad ( 4 )$$
wherein M, C, K respectively denote a mass matrix, a damping matrix, and a stiffness matrix of the structure; xᵢ, \dot{x}ᵢ, \ddot{x}ᵢ respectively denote a displacement, a velocity, and an acceleration of an i^{th} layer; i=1,2, . . . , n; fᵢ denotes a restoring force of an i^{th}-layer fractional-order damper; and Λ denotes a positioning matrix of the restoring force of the damper;
for the restoring force model of the fractional-order damper:
a material constitutive equation of the fractional-order damper is described by using a generalized stress-strain relationship defined by Kasai:
τ(t)+aD^{δ}τ(t)=G(γ(t)+bD^{δ}γ(t) (5),
wherein τ(t) and γ(t) denote a shear stress and a shear strain of a material; G denotes an elastic parameter of the material: δ denotes a fractional order, 0<δ<1; a, b denote temperature and frequency-equivalent parameters; and D^{δ}=d^{δ}/dt^{δ} denotes an RL-type fractional-order derivative operator and is defined as follows:
$${D}^{δ} g ( t ) = \frac{1}{Γ ( 1 - δ )} \frac{d}{dt} {\int }_{0}^{t} \frac{g ( ζ )}{{( t - ζ )}^{δ}} d ζ , \qquad ( 6 )$$
wherein Γ(·) denotes a Gamma function;
it can be learned from Formula (5) that a relationship between the restoring force of the i^{th} damper and a displacement of each particle is as follows:
$${f}_{i} ( t ) + a {D}^{δ} {f}_{i} ( t ) = {k}^{′} ( {x}_{i} ( t ) - {x}_{i - 1} ( t ) ) + {k}^{′} b {D}^{δ} ( {x}_{i} ( t ) - {x}_{i - 1} ( t ) ) , \qquad ( 7 )$$
wherein k′=GA/h; and A and h respectively denote an area and a thickness of a damper;
under a condition of 0<δ<1, an RL-type fractional-order derivative is allowed to be converted to an expression of a Caputo-type fractional-order derivative:
$${D}^{δ} g ( t ) = {}^{C} {D}^{δ} g ( t ) + \frac{{t}^{- δ} g ( 0 )}{Γ ( 1 - δ )} , \qquad ( 8 )$$
wherein ^{C}D^{δ} denotes a Caputo-type fractional-order derivative operator and is defined as follows:
$${}^{C} {D}^{δ} g ( t ) = \frac{1}{Γ ( 1 - δ )} {\int }_{0}^{t} \frac{\dot{g} ( ζ )}{{( t - ζ )}^{δ}} d ζ , \qquad ( 9 )$$
wherein at an tₚ^{th} discrete moment, the Caputo-type fractional-order derivative based on the Adams-Moulton algorithm is solved as follows:
$${}^{C} {D}^{δ} g ( t ) = \frac{Δ {t}^{1 - δ}}{Γ ( 3 - δ )} {\sum }_{j = 0}^{p} {q}_{j , p} \dot{g} ( {t}_{j} ) , \qquad ( 10 )$$
wherein p=tₚ/Δt; and q_{j,p} is solved as follows:
if j=0,
q_{j,p}=(p−1)^{2-δ}−p^{1-δ}(p+δ−2); (1)
if 0<j<p,
q_{j,p}=(p−j−1)^{2-δ}−2(p−j)^{2-δ}−(p−j+1)^{2-δ}; and (2)
if j=p,
q_{j,p}−1. (3)
wherein according to Formula (7), when g(t) is fᵢ(t), , ġ(tⱼ) is approximately calculated by using a first-order difference [fᵢ(tⱼ)−fᵢ(tⱼ₋₁)]/Δt; and when g(t) is xᵢ(t)−xᵢ₋₁(t), g(tⱼ) is equal to \dot{x}ᵢ(tⱼ)−\dot{x}ᵢ₋₁(tⱼ);
the step of constructing the equivalent linear time-invariant dynamic system is implemented as follows:
at a tₚ^{th} discrete moment, it can be learned, by combining Formulas (2), (3), and (7), that a damping force vector and a particle displacement vector satisfy the following relationship:
$$F ( {t}_{p} ) = - a {D}^{δ} F ( {t}_{p} ) + {k}^{′} {Λ}^{T} X ( {t}_{p} ) + {k}^{′} b {Λ}^{T} {D}^{δ} X ( {t}_{p} ) ; \qquad ( 11 )$$
$$and$$
with reference to Formulas (8) and (12), numerical solution expression is performed on D^{δ}F(tₚ) and D^{δ}X(tₚ), then results are substituted into Formula (11), and finally the following formula is acquired via sorting:
$$F ( {t}_{p} ) = \frac{λ Δ t}{μ + Δ t} {Λ}^{T} \dot{X} ( {t}_{p} ) + \frac{{k}^{′} Δ t}{μ + Δ t} {Λ}^{T} X ( {t}_{p} ) - B ( {t}_{p} ) , \qquad ( 12 )$$
$$wherein$$
$$μ = \frac{a Δ {t}^{1 - δ}}{Γ ( 3 - δ )} ; \qquad ( 13 )$$
$$λ = \frac{{k}^{′} b Δ {t}^{1 - δ}}{Γ ( 3 - δ )} ; \qquad ( 14 )$$
$$and$$
$$B ( {t}_{p} ) = - \frac{λ Δ t}{μ + Δ t} {Λ}^{T} {\sum }_{j = 1}^{p - 1} {q}_{j , p} \dot{X} ( {t}_{j} ) + \frac{μ Δ t}{μ + Δ t} \cdot ( {\sum }_{j = 1}^{p - 1} {q}_{j , p} \frac{F ( {t}_{j} ) - F ( {t}_{j - 1} )}{Δ t} - \frac{F ( {t}_{p - 1} )}{Δ t} ) , \qquad ( 15 )$$
wherein B(tₚ) is simplified by using a zero initial condition, that is, F(0)=\dot{F}(0)=X(0)=\dot{X}(0)=0; and
Formula (12) is substituted into the integral motion equation (1) of the structure at the tₚ^{th} discrete moment, and finally the following formula is acquired via sorting:
$$M \ddot{X} ( {t}_{p} ) + \overline{C} \dot{X} ( {t}_{p} ) + \overline{K} X ( {t}_{p} ) = \overline{P} ( {t}_{p} ) , \qquad ( 16 )$$
$$wherein$$
$$\overline{C} = C + \frac{λ Δ t}{μ + Δ t} Λ {Λ}^{T} ; \qquad ( 17 )$$
$$\overline{K} = K + \frac{{k}^{′} Δ t}{μ + Δ t} Λ {Λ}^{T} ; \qquad ( 18 )$$
$$and$$
$$\overline{P} ( {t}_{p} ) = P ( {t}_{p} ) + Λ B ( {t}_{p} ) . \qquad ( 19 )$$

4. An electronic device, comprising a processor and a memory, wherein the memory is configured to store at least one instruction, at least one program, a code set, or an instruction set; and the at least one instruction, the at least one program, the code set, or the instruction set is loaded and executed by the processor, to implement the method for analyzing the anti-earthquake design of the fractional-order damping and vibration-reducing structure according to claim 1.

5. A non-transitory computer-readable storage medium, wherein the non-transitory computer-readable storage medium is configured to store at least one instruction, at least one program, a code set, or an instruction set; and the at least one instruction, the at least one program, the code set, or the instruction set is loaded and executed by a processor, to implement the method for analyzing the anti-earthquake design of the fractional-order damping and vibration-reducing structure according to claim 1.

6. The electronic device according to claim 4, wherein in the method for analyzing the anti-earthquake design of the fractional-order damping and vibration-reducing structure,
the step of establishing the explicit solution formula of the equivalent linear time-invariant dynamic system at each moment with reference to Newmark-β numerical integration comprises:
establishing moment-by-moment solution formulas of the dynamic response based on Newmark-β, the formulas being as follows:
$$X ( {t}_{p} ) = {\tilde{K}}^{- 1} \tilde{P} ( {t}_{p} ) ; \qquad ( 20 )$$
$$\dot{X} ( {t}_{p} ) = {a}_{1} ( X ( {t}_{p} ) - X ( {t}_{p - 1} ) ) - {a}_{4} \dot{X} ( {t}_{p - 1} ) - {a}_{5} \ddot{X} ( {t}_{p - 1} ) ; \qquad ( 21 )$$
$$\ddot{X} ( {t}_{p} ) = {a}_{0} ( X ( {t}_{p} ) - X ( {t}_{p - 1} ) ) - {a}_{2} \dot{X} ( {t}_{p - 1} ) - {a}_{3} \ddot{X} ( {t}_{p - 1} ) ; \qquad ( 22 )$$
$$and$$
$$F ( {t}_{p} ) = \frac{λ Δ t}{μ + Δ t} {Λ}^{T} \dot{X} ( {t}_{p} ) + \frac{{k}^{′} Δ t}{μ + Δ t} {Λ}^{T} X ( {t}_{p} ) - B ( {t}_{p} ) , \qquad ( 23 )$$
$$wherein$$
$$\tilde{K} = \overline{K} + {a}_{0} M + {a}_{1} \overline{C} ; \qquad ( 24 )$$
$$\tilde{P} ( {t}_{p} ) = P ( {t}_{p} ) + Λ B ( {t}_{p} ) + M ( {a}_{0} X ( {t}_{P - 1} ) + {a}_{2} \dot{X} ( {t}_{P - 1} ) + {a}_{3} \ddot{X} ( {t}_{P - 1} ) ) + \overline{C} ( {a}_{1} X ( {t}_{P - 1} ) + {a}_{4} \dot{X} ( {t}_{P - 1} ) + {a}_{5} \ddot{X} ( {t}_{P - 1} ) ) ; \qquad ( 25 )$$
$$and$$
$$\{ \begin{matrix}{a}_{0} = 1 / ( βΔ {t}^{2} ) & {a}_{1} = γ / ( βΔ t ) \\ {a}_{2} = 1 / ( βΔ t ) & {a}_{3} = 1 / ( 2 β ) - 1 \\ {a}_{4} = γ / β - 1 & {a}_{5} = Δ t ( γ / β - 2 ) / 2\end{matrix} , \qquad ( 26 )$$
wherein p=1,2, . . . , n.

7. The computer-readable storage medium according to claim 5, wherein in the method for analyzing the anti-earthquake design of the fractional-order damping and vibration-reducing structure,
the step of establishing the explicit solution formula of the equivalent linear time-invariant dynamic system at each moment with reference to Newmark-β numerical integration comprises:
establishing moment-by-moment solution formulas of the dynamic response based on Newmark-β, the formulas being as follows:
$$X ( {t}_{p} ) = {\tilde{K}}^{- 1} \tilde{P} ( {t}_{p} ) ; \qquad ( 20 )$$
$$\dot{X} ( {t}_{p} ) = {a}_{1} ( X ( {t}_{p} ) - X ( {t}_{p - 1} ) ) - {a}_{4} \dot{X} ( {t}_{p - 1} ) - {a}_{5} \ddot{X} ( {t}_{p - 1} ) ; \qquad ( 21 )$$
$$\ddot{X} ( {t}_{p} ) = {a}_{0} ( X ( {t}_{p} ) - X ( {t}_{p - 1} ) ) - {a}_{2} \dot{X} ( {t}_{p - 1} ) - {a}_{3} \ddot{X} ( {t}_{p - 1} ) ; \qquad ( 22 )$$
$$and$$
$$F ( {t}_{p} ) = \frac{λ Δ t}{μ + Δ t} {Λ}^{T} \dot{X} ( {t}_{p} ) + \frac{{k}^{′} Δ t}{μ + Δ t} {Λ}^{T} X ( {t}_{p} ) - B ( {t}_{p} ) , \qquad ( 23 )$$
$$wherein$$
$$\tilde{K} = \overline{K} + {a}_{0} M + {a}_{1} \overline{C} ; \qquad ( 24 )$$
$$\tilde{P} ( {t}_{p} ) = P ( {t}_{p} ) + Λ B ( {t}_{p} ) + M ( {a}_{0} X ( {t}_{P - 1} ) + {a}_{2} \dot{X} ( {t}_{P - 1} ) + {a}_{3} \ddot{X} ( {t}_{P - 1} ) ) + \overline{C} ( {a}_{1} X ( {t}_{P - 1} ) + {a}_{4} \dot{X} ( {t}_{P - 1} ) + {a}_{5} \ddot{X} ( {t}_{P - 1} ) ) ; \qquad ( 25 )$$
$$and$$
$$\{ \begin{matrix}{a}_{0} = 1 / ( βΔ {t}^{2} ) & {a}_{1} = γ / ( βΔ t ) \\ {a}_{2} = 1 / ( βΔ t ) & {a}_{3} = 1 / ( 2 β ) - 1 \\ {a}_{4} = γ / β - 1 & {a}_{5} = Δ t ( γ / β - 2 ) / 2\end{matrix} , \qquad ( 26 )$$
wherein p=1,2, . . . , n.
